(19) United States
(12) Patent Application Publication
(10) Pub. No.: US 2012/0127458 A1
(43) Pub. Date: May 24, 2012

(54) MULTI-FUNCTION OPTICAL MEASUREMENT DEVICE

(75) Inventors: Kwon-Seob LIM, Gwangju (KR); Hyun Seo KANG, Gwangju (KR); Gwang Su YUN, Gwangju (KR); Chong Hee YU, Gwangju (KR); Jai Sang KOH, Gwangju (KR)

(73) Assignee: Electronics and Telecommunications Research Institute, Daejon (KR)

(21) Appl. No.: 13/301,030

(22) Filed: Nov. 21, 2011

(30) Foreign Application Priority Data
Nov. 22, 2010 (KR) 10-2010-0116334

(51) Int. Cl. G01J 1/42

(52) U.S. Cl. 356/73

(57) ABSTRACT

A multi-function optical measurement device having an optical wavelength and power measurement function, a ferrule/fiber scoping function, and a ferrule/fiber cleaning function includes a path select unit separating an optical signal for transmission and an optical signal for scoping from a ferrule/fiber; a wavelength and power measurement unit measuring a wavelength and a power of the optical signal for transmission from the path select unit; and a ferrule/fiber scoping unit converting an optical signal for scoping from the path select unit into an electrical signal. It is possible to perform a wavelength and power measurement and a ferrule/fiber scoping by one connection. Since a ferrule/fiber cleaning may be additionally included in one measurement device, it is easy to handle and carry an optical measurement device. A time required to perform a work using an optical measurement device may be reduced.

### CROSS-REFERENCE TO RELATED APPLICATIONS

This U.S. non-provisional patent application claims priority under 35 U.S.C. §119 of Korean Patent Application No. 10-2010-0116334, filed on Nov. 22, 2010, the entire contents of which are hereby incorporated by reference.

### BACKGROUND

The present inventive concept herein relates to measurement devices, and more particularly, to a multi-function optical measurement device in which an optical wavelength and power measurement function, a ferrule/fiber scoping function and a ferrule/fiber cleaning function are amalgamated.

An optical communication has a lot of advantages in transmission capacity, reliability and distance of transmission as compared with an electrical communication. However, because an optical communication uses a light as the signal transmission media, different techniques from an electrical communication are required in a light source, a modulation method, a multiplexing method, a coupler and an optical cable.

There are two methods in optical multiplexing method. One is an optical time division multiplexing method and the other is an optical wavelength division multiplexing method. In the optical time division multiplexing method, information is divided by a specific time and in the wavelength division multiplexing method, information is loaded on carriers having different frequencies. The wavelength division multiplexing method may transmit a plurality of lights having different wavelengths through one optical cable. Thus, the wavelength division multiplexing method is very effective at increasing data transmission speed and may be applied to high speed telecommunications.

Also, an optical communication transmits data through an optical cable. Since an optical cable is set to be long, a connection and a branch of optical cable are required. However, because optical fibers having a very small diameter are formed inside the optical cable, it is not easy to connect the optical fibers to one another. It is more difficult to connect the optical fibers in the case of an optical cable that should connect many optical fibers at one time. When connecting and branching off an optical fiber, a connector is used. At this time, a ferrule is used so that end cross sections of the optical fibers are in contact with one another.

In the wavelength division multiplexing method, it is important to maintain a constant optical wavelength and a constant optical power. Thus, a measurement device for measuring an optical wavelength and an optical power is needed. Also, it is required that the ferrule is not contaminated. If the ferrule is contaminated, optical fibers are not exactly connected to one another. Thus, it is required to measure a degree of contamination of the ferrule (ferrule scoping) and remove contamination of the ferrule (ferrule cleaning).

### SUMMARY

Embodiments of the inventive concept provide a multi-function optical measurement device. The multi-function optical measurement device may include a path select unit separating two optical signals to distinguish between one optical signal from a ferrule/fiber and another optical signal from a ferrule/fiber scoping unit; a wavelength and power measurement unit measuring a wavelength and a power of the optical signal from the path select unit; and a ferrule/fiber scoping unit converting an optical signal for scoping from the path select unit into an electrical signal.

### BRIEF DESCRIPTION OF THE FIGURES

The foregoing and other features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention. In the drawings, the thickness of layers and regions are exaggerated for clarity.

FIG. 1 is a drawing illustrating a general optical ferrule.

FIG. 2 is a drawing illustrating a multi-function optical measurement device in accordance with the present invention.

FIGS. 3A and 3B are block diagrams illustrating a path select unit of multi-function optical measurement device in accordance with the present invention.

FIGS. 4 through 8 are drawings illustrating a wavelength of multi-function optical measurement device and embodiments of power measurement unit in accordance with the present invention.

### DETAILED DESCRIPTION OF THE EMBODIMENTS

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

Conventional optical measurement devices perform one function or two functions among functions of optical wavelength measurement, optical power measurement, ferrule scoping and ferrule cleaning. In this case, because equipments having each function have to be separately purchased, it is not easy to handle and carry the equipment. Also, because works such as an optical wavelength measurement, an optical power measurement and a ferrule scoping are not processed by one operation, a lot of working time is required.

The present inventive concept provides a multi-function fusion optical measurement device fusing functions of optical wavelength measurement, optical power measurement, ferrule scoping and ferrule cleaning. In particular, the present inventive concept provides a multi-function conversed optical measurement device that can measure and observe the functions of optical wavelength measurement, optical power measurement and ferrule scoping at the same time by one connection. According to the inventive concept, a light source having a plurality of wavelengths can be measured at the same time.

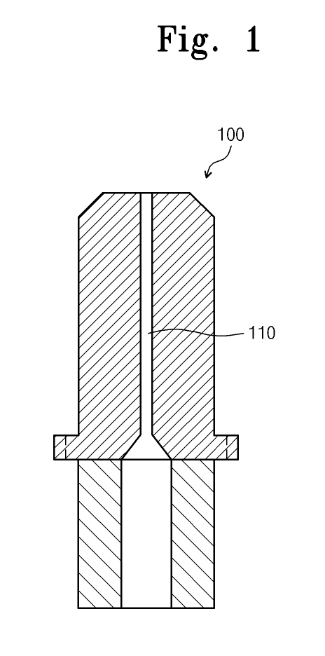

FIG. 1 is a drawing illustrating a general optical ferrule. Referring to FIG. 1, a hole 110 having a cylindrical shape into which optical fibers are inserted is formed inside the optical ferrule 100.

To transmit a high speed optical signal, it is required that a ferrule side and a ferrule side are precisely connected to each other. If a ferrule side is contaminated, ferrule sides are not precisely connected to each other. Thus, it is required to remove ferrule contamination before connecting the ferrule 100.

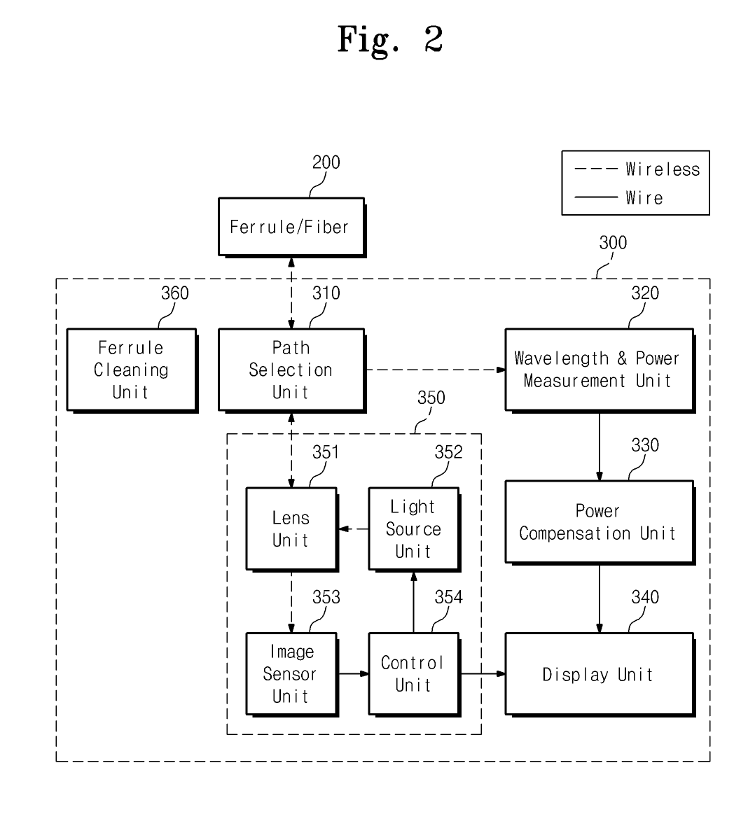

FIG. 2 is a drawing illustrating a multi-function optical measurement device in accordance with the present invention. Referring to FIG. 2, a multi-function optical measurement device 300 may include a path select unit 310, a wavelength and power measurement unit 320, a power compensation unit 330, a display unit 340, a ferrule/fiber scoping unit 350 and a ferrule cleaning unit 360.

The path select unit 310 transmits an optical signal from a ferrule/fiber 200 to the wavelength and power measurement unit 320. The optical signal for transmission signifies an optical signal including data.

The wavelength and power measurement unit 320 receives an optical signal for transmission from the path select unit 310. The wavelength and power measurement unit 320 measures a wavelength and a power of the received optical signal for transmission. The wavelength and power measurement unit 320 transmits the measurement result to the power compensation unit 330.

The power compensation unit 330 compensates the measurement result from the wavelength and power measurement unit 320. More specifically, the power compensation unit 330 compensates the measurement result in the light of loss of path (ferrule/fiber-fiber select unit-wavelength and power measurement unit). For example, in the case that loss of path is −5 dBm, the power compensation unit 330 may add 5 dBm to the measurement result. The power compensation unit 330 transmits the compensation result to the display unit 340. The display unit 340 outputs the received compensation result in the form of numerical data.

The ferrule/fiber scoping unit 350 may include a lens unit 351, a light source unit 352, an image sensor unit 353 and a control unit 354. The control unit 354 controls the whole operation of the ferrule/fiber scoping unit 350. The light source unit 352 generates an optical signal for scoping. The optical signal for scoping means is an optical signal for measuring a degree of contamination of the ferrule/fiber 200. The optical signal for scoping is transmitted to the lens unit 351. The lens unit 351 transmits the optical signal for scoping to the path select unit 310.

The path select unit 310 transmits the optical signal for scoping from the lens unit 351 to the ferrule/fiber 200. The optical signal for scoping is reflected by the ferrule/fiber 200. The path select unit 310 transmits the optical signal for scoping reflected by the ferrule/fiber 200 to the lens unit 351.

The lens unit 351 transmits the reflected optical signal for scoping to the image sensor unit 353. The image sensor unit 353 converts the reflected optical signal for scoping into an electrical signal. The image sensor unit 353 transmits the electrical signal to the display unit 340. The display unit 340 outputs a cross section of the ferrule/fiber 200 in the form of image data depending on the received electrical signal. If the ferrule is contaminated, a contamination source may be removed using the ferrule cleaning unit 360.

As described above, an optical wavelength measurement, an optical power measurement and a ferrule scoping may be performed at the same time by only connecting the ferrule/fiber 200 to the multi-function optical measurement device in accordance with the inventive concept. Also, portions indicated by a dotted line represent that an optical signal is transmitted by wireless. Thus, additional parts for optical transmission are not required and a structure may become simple.

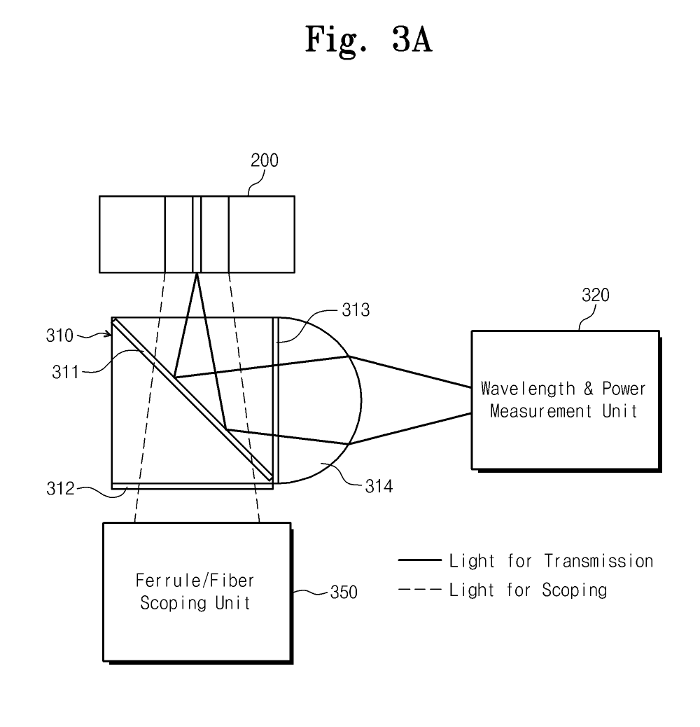

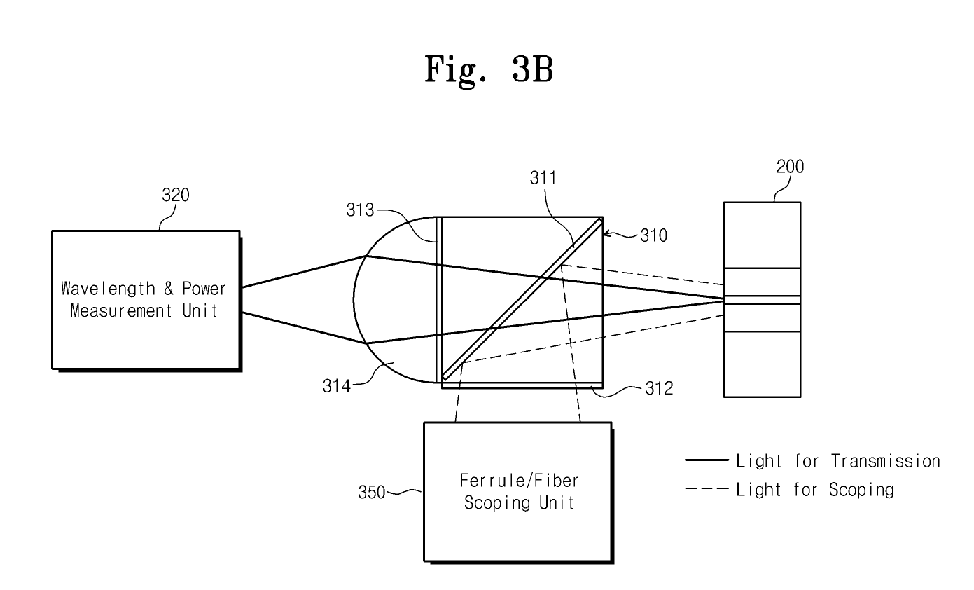

FIGS. 3A and 3B are block diagrams illustrating a path select unit of multi-function optical measurement device in accordance with the present invention.

Referring to FIG. 3A, a multi-function optical measurement device in accordance with the present invention may include the path select unit 310, the wavelength and power measurement unit 320 and the ferrule/fiber scoping unit 350. The path select unit 310 includes WDM filter 311 and a lens 314 and may further include a first cutoff filter 312 and a second cutoff filter 313.

The WDM filter 311 in the path select unit 310 reflects an optical signal for transmission from the ferrule/fiber 200 and transmits the reflected optical signal for transmission to the power measurement unit 320. The WDM filter 311 passes an optical signal for transmission from the ferrule/fiber scoping unit 350. The passed optical signal for scoping is reflected by the ferrule/fiber 200. The WDM filter 311 transmits an optical signal for scoping reflected by the ferrule/fiber 200 to the ferrule/fiber scoping unit 350.

The first cutoff filter 312 cutoffs an optical signal for transmission not cutoff by the WDM filter 311. The second cutoff filter 313 cutoffs an optical signal for scoping so that the optical signal for scoping is not transmitted to the wavelength and power measurement unit 320. The lens 314 collects optical signals for transmission reflected by the WDM filter 311 and transmits them to the wavelength and power measurement unit 320.

Referring to FIG. 3B, a multi-function optical measurement device in accordance with the present invention includes a path select unit 310, a wavelength and power measurement unit 320 and a ferrule/fiber scoping unit 350. The path select unit 310 includes a WDM filter 311 and a lens 314 and may further include a first cutoff filter 312 and a second cutoff filter 312.

The WDM filter 311 in the path select unit 310 transmits an optical signal for transmission from the ferrule/fiber 200 and sends it to the wavelength and power measurement unit 320. Also, the WDM filter 311 reflects an optical signal for scoping from the ferrule/fiber scoping unit 350. The reflected optical signal for scoping is reflected by the ferrule/fiber 200. The WDM filter 311 transmits the optical signal for scoping reflected by the ferrule/fiber 200 to the ferrule/fiber scoping unit 350.

The first cutoff filter 312 cutoffs an optical signal for transmission not cutoff by the WDM filter 311. The second cutoff filter 313 cutoffs an optical signal for scoping so that the optical signal for scoping is not transmitted to the wavelength and power measurement unit 320. The lens 314 collects optical signals for transmission reflected by the WDM filter 311 and transmits them to the wavelength and power measurement unit 320.

As described above, it is possible to perform multi-functions at the same time by separating the optical signal for transmission and the optical signal for scoping through the path select unit 310.

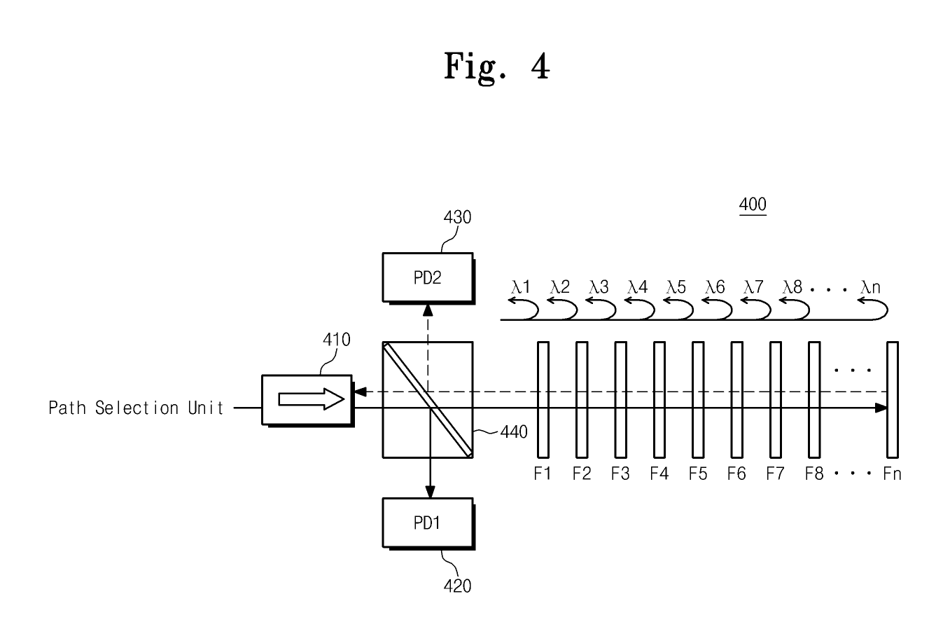

FIG. 4 is a drawing illustrating a wavelength of multi-function optical measurement device and some embodiments of power measurement unit. Referring to FIG. 4, a wavelength and power measurement unit 400 includes an isolator 410, a first photodetector 420, a second photodetector 430, a splitter 440 and a plurality of WDM filters F1˜Fn.

The isolator 410 receives an optical signal for transmission from the path select unit 310. Also, the isolator 410 cutoffs an optical signal for transmission from the splitter 440 so that the optical signal for transmission is not transmitted to the path select unit 310.

The splitter 440 transmits a part of optical signal for transmission from the isolator 410 to the first photodetector 420. The splitter 440 transmits the rest of optical signal for transmission from the isolator 410 to the plurality of WDM filters F1˜Fn.

Each of the WDM filters F1˜Fn is configured to reflect an optical signal having a different wavelength. For example, after an optical signal having a wavelength λ1 is reflected by a first WDM filter F1, a part of the optical signal may be transmitted to the second photodetector 430 by the splitter 440.

Since times during which reflected optical signals are transmitted to the second photodetector 430 are different depending on each wavelength, it is possible to measure wavelength information and an optical power of corresponding wavelength at the same time. That is, since a difference between times when the optical signals are detected in the first photodetector 420 and the second photodetector 430 is different depending on each wavelength, wavelength information may be known by a time difference of being detected. A detection time difference between the first and second photodetectors 420 and 430 in accordance with each wavelength may be defined.

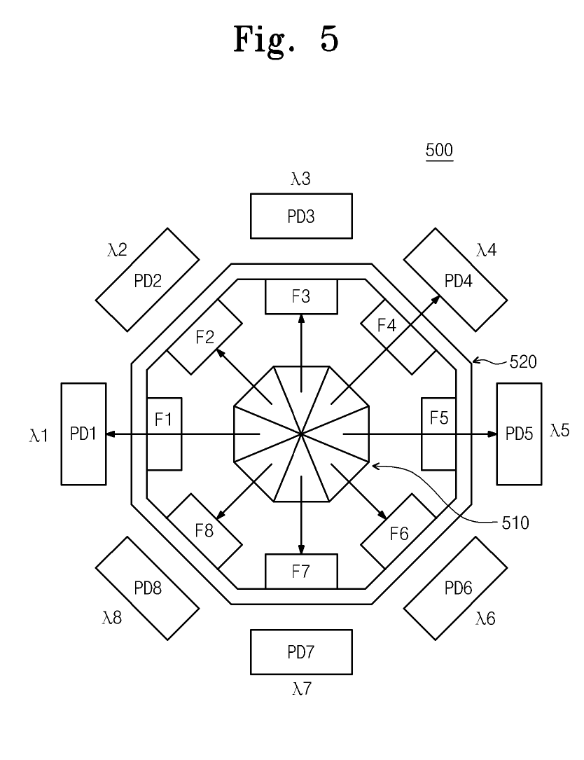

FIG. 5 is a drawing illustrating a wavelength of multi-function optical measurement device and some embodiments of power measurement unit. Referring to FIG. 5, a wavelength and power measurement unit 500 includes a mirror 510 of octagonal pyramid shape, a plurality of WDM filters F1˜F8, a filter holder 520 and a plurality of photodetectors PD1˜PD8.

The mirror 510 of octagonal pyramid shape transmits a light source from a pyramid direction to the plurality of WDM filters F1˜F8. Each of the filters F1˜F8 passes light sources having different wavelengths. For example, a first filter F1 may pass an optical signal having a wavelength of λ1. An optical signal that passed through the filter is transmitted to the photodetector. An optical signal that passed through the first filter F1 may be transmitted to the first photodetector PD1.

In the present embodiment, the mirror 510 of octagonal pyramid shape is illustrated but the inventive concept is not limited thereto. The mirror may have a polypyramid shape and a quantity of filters and photodetectors may vary accordingly.

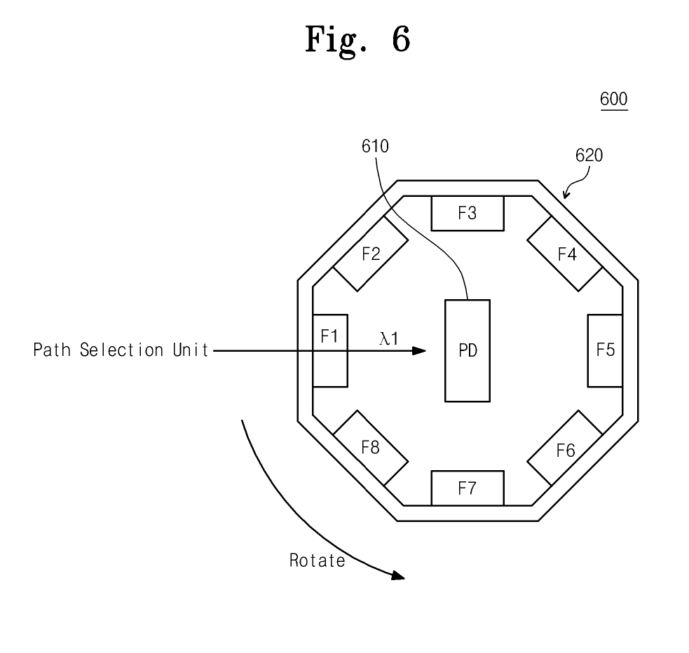

FIG. 6 is a drawing illustrating a wavelength of multi-function optical measurement device and some embodiments of power measurement unit. Referring to FIG. 6, a wavelength and power measurement unit 600 includes a photodetector 610, a plurality of WDM filters F1˜F8 and a filter holder 620.

Referring to FIG. 6, the filter holder 620 includes a plurality of filters F1˜F8. As the filter holder 620 rotates, the filters F1˜F8 built in the filter holder 620 also rotate. Each of the filters F1˜F8 passes an optical signal having a different wavelength. For example, the first filter F1 may pass an optical signal having a wavelength of λ1.

As the filter holder 620 rotates, optical signals having different wavelengths may be transmitted to the photodetector. Thus, it is possible to measure powers of a plurality of optical signals by only one photodetector.

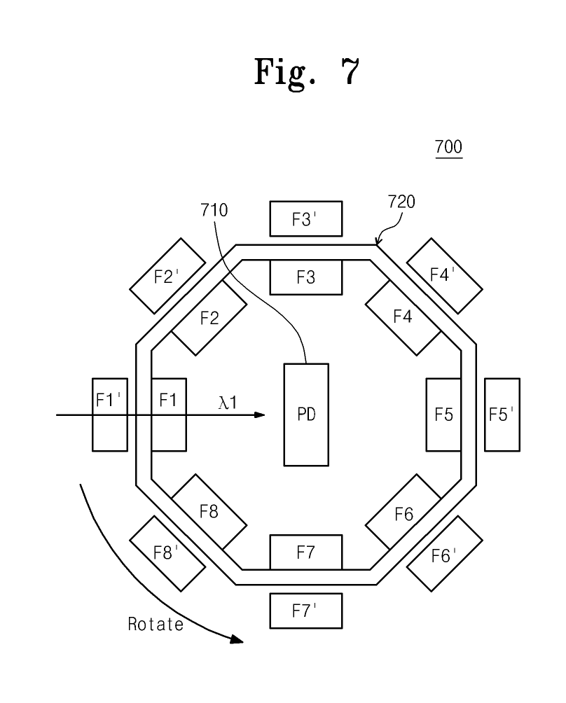

FIG. 7 is a drawing illustrating a wavelength of multi-function optical measurement device and some embodiments of power measurement unit. Referring to FIG. 5, a wavelength and power measurement unit 700 includes a photodetector 710, a plurality of WDM filters F1˜F8, a filter holder and a plurality of additional WDM filters F1′18 F8′.

Since an isolation characteristic of general WDM filter is about 30 dB, it is difficult to measure an optical power of wavelength having a difference of more than 30 Db. The WDM filters F1′˜F8′ are additionally mounted opposite the filter holder fitted with the WDM filters F1˜F8, thereby obtaining an isolation characteristic of about 60 dB.

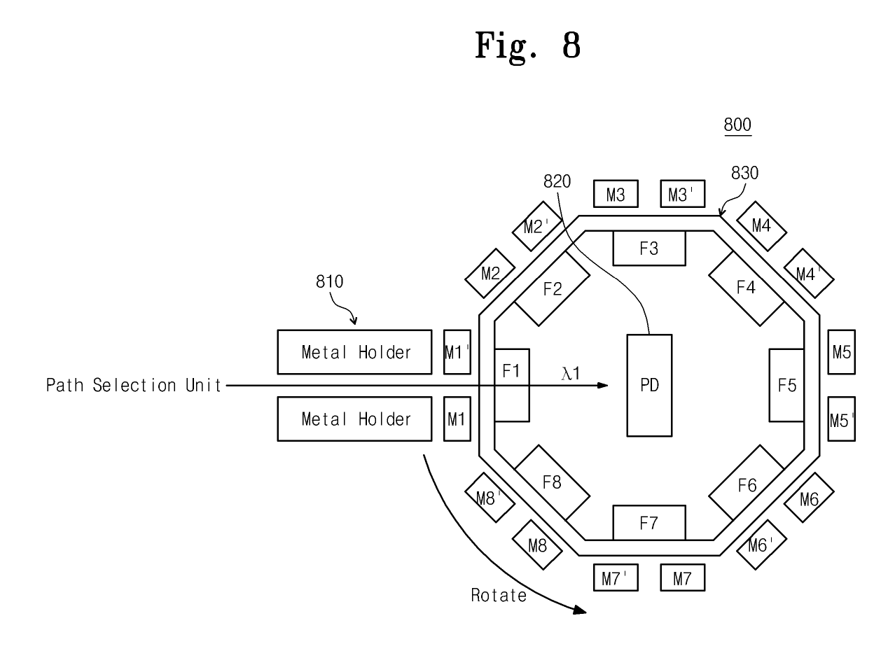

FIG. 8 is a drawing illustrating a wavelength of multi-function optical measurement device and some embodiments of power measurement unit. Referring to FIG. 8, a wavelength and power measurement unit 800 includes a metal holder 810, a photodetector 820, a plurality of WDM filters F1˜F8, a filter holder 830 and a plurality of magnets M1˜M8 and M1′˜M8′.

When rotating the filter holder 830, the filter holder 830 has to be precisely rotated only by an arbitrary specific angle. This is because if the filter holder 830 rotates by a greater angle or a smaller angle than a predetermined angle, an error may occur in an optical power value due to a reflection and a refraction of a light source.

To prevent this, as illustrated in FIG. 8, magnets M1˜M8 and M1′˜M8′ are attached to each side of the filter holder 830 and the metal holder 810 is mounted in the direction in which a light source is input. As a result, it is possible for the filter holder 830 to regularly rotate using magnetism. Also, the metal holder 810 performs a function of guide of an optical signal, thereby preventing a leakage of an optical signal. As illustrated in FIG. 7, an additional isolation characteristic may be obtained by mounting the WDM filters on the filter holder 830.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A multi-function optical measurement device comprising:
a path select unit separating an optical signal for transmission and an optical signal for scoping from a ferrule/fiber;
a wavelength and power measurement unit measuring a wavelength and a power of the optical signal for transmission from the path select unit; and
a ferrule/fiber scoping unit converting an optical signal for scoping from the path select unit into an electrical signal.

2. The multi-function optical measurement device of claim 1, wherein the ferrule/fiber scoping unit generates the optical signal for scoping and transmits the generated optical signal for scoping to the path select unit and wherein the path select unit transmits the optical signal for scoping to the ferrule/fiber.

3. The multi-function optical measurement device of claim 1, wherein the path select unit is optically connected to the ferrule/fiber or the wavelength and power measurement unit or the ferrule/fiber scoping unit one another.

4. The multi-function optical measurement device of claim 1, wherein the ferrule/fiber scoping unit comprises:
a light source unit generating an optical signal for scoping;
an image sensor unit converting the optical signal for scoping into an electrical signal;
a lens unit transmitting the optical signal for scoping from the light source unit to the path select unit and transmitting the optical signal for scoping from the path select unit to the image sensor; and
a control unit controlling the light source unit, the image sensor unit and the lens unit.

5. The multi-function optical measurement device of claim 4, wherein the lens unit is optically connected to the path select unit or the light source unit or the image sense unit one another.

6. The multi-function optical measurement device of claim 1, further comprising a ferrule cleaning unit for removing contamination of the ferrule/fiber.

7. The multi-function optical measurement device of claim 1, wherein the path select unit comprises:
a WDM filter reflecting the optical signal for transmission from the ferrule/fiber and transmitting the optical signal for transmission to the wavelength and power measurement unit and passing the optical signal for scoping from the ferrule/fiber and transmitting the optical signal for scoping to the ferrule/fiber scoping unit; and
a lens collecting the reflected optical signal for transmission to transmit the reflected optical signal for transmission to the wavelength and power measurement unit.

8. The multi-function optical measurement device of claim 1, wherein the path select unit comprises:
A WDM filter passing the optical signal for transmission from the ferrule/fiber and transmitting the optical signal for transmission to the wavelength and power measurement unit and reflecting the optical signal for scoping from the ferrule/fiber and transmitting the optical signal for scoping to the ferrule/fiber scoping unit; and
a lens collecting the passed optical signal for transmission to transmit the passed optical signal for transmission to the wavelength and power measurement unit.

9. The multi-function optical measurement device of claim 1, wherein the path select unit comprises:
a first cutoff filter preventing the optical signal for transmission from being transmitted to the ferrule/fiber scoping unit; and
a second cutoff filter preventing the optical signal for scoping from being transmitted to the wavelength and power measurement unit.

10. The multi-function optical measurement device of claim 1, wherein the wavelength and power measurement unit comprises:
an isolator passing the optical signal for transmission from the path select unit in a specific direction;
a splitter separating the optical signal for transmission;
a first photodetector receiving the optical signal for transmission from the splitter;
a plurality of filters reflecting the optical signal for transmission from the splitter at a different time depending on a wavelength of the optical signal; and
a second photodetector receiving the reflected optical signal for transmission.

11. The multi-function optical measurement device of claim 10, wherein the wavelength and power measurement unit measures a wavelength and a power of the optical signal for transmission with reference to a time at which the first photodetector receives the optical signal for transmission and a time at which the second photodetector receives the optical signal for transmission.

12. The multi-function optical measurement device of claim 1, wherein the wavelength and power measurement unit comprises:
a mirror having a pyramid shape separating the optical signal for transmission from the path select unit;
a plurality of filters selectively passing the optical signal for transmission from the mirror of a pyramid shape; and
a plurality of photodetectors detecting the optical signals for transmission that passed through the plurality of filters while corresponding to the plurality of filters.

13. The multi-function optical measurement device of claim 12, wherein the wavelength and power measurement unit further comprises a plurality of additional filters respectively corresponding to the plurality of filters and selectively passing the optical signal for transmission from the path select unit according to a rotation.

14. The multi-function optical measurement device of claim 1, wherein the wavelength and power measurement unit comprises:
a plurality of filters selectively passing the optical signal for transmission from the path select unit according to a rotation; and
a photodetector detecting the optical signal for transmission that passed through the plurality of filters.

15. The multi-function optical measurement device of claim 14, wherein the wavelength and power measurement unit further comprises a plurality of additional filters respectively corresponding to the plurality of filters and selectively passing the optical signal for transmission from the path select unit according to a rotation.

16. The multi-function optical measurement device of claim 14, wherein the wavelength and power measurement unit comprises:
a plurality of magnets corresponding to the plurality of filters respectively; and
a metal holder magnetically combining with the magnets to maintain a constant angle of rotation and guide the optical signal for transmission.

17. The multi-function optical measurement device of claim 16, wherein the wavelength and power measurement unit further comprises a plurality of additional filters respectively corresponding to the plurality of filters and selectively passing the optical signal for transmission from the path select unit according to a rotation.
